(19) United States
(12) Patent Application Publication
(10) Pub. No.: US 2024/0336290 A1
(43) Pub. Date: Oct. 10, 2024

(54) CART WITH SLIDERS

(71) Applicant: Zhejiang Pride Leisure Products Co,. Ltd., Jinhua (CN)

(72) Inventor: Benlong SUN, Jinhua (CN)

(21) Appl. No.: 18/629,928

(22) Filed: Apr. 8, 2024

(30) Foreign Application Priority Data
Apr. 6, 2023 (CN) 202320729071X

(51) Int. Cl. B62B 3/00; B62B 3/02; B62B 5/06

(52) U.S. Cl. CPC B62B 3/007; B62B 3/025; B62B 5/067; B62B 2205/06

(57) ABSTRACT

A cart with sliders having a hand lever, a front frame, a back frame, two symmetrical side frames and a chassis, wherein the hand lever is rotatably connected with the front frame, the front frame and the back frame are identical in structure, each of the side frames having two X-shaped cross tubes and two sliders, the chassis having a bottom tube and two bottom frames, one ends of the two bottom frames are articulated, the other ends of the two bottom frames are riveted to the front frame and the back frame respectively, the bottom tube is arranged below the bottom frames, and two ends of the bottom tube are riveted to an upper articulated joint of the two X-shaped cross tubes of one side frame and an upper articulated joint of the two X-shaped cross tubes of the other side frame respectively.

### BACKGROUND OF THE INVENTION

### 1. Technical Field

The invention belongs to the technical field of carts, particularly relates to a cart with sliders.

### 2. Description of Related Art

Most existing carts consist of casters, a hand lever and a basket, wherein the hand lever is mounted on one side of the basket, the casters are arranged at the bottom of the basket, and the basket is used for storing articles and is generally assembled on a base in a non-detachable manner. Due to the fact that such carts cannot be folded, the transport cost is high, the wastage during the transporting process is large, and the carts are inconvenient to store. There are also some folding carts that can be folded to be transported and carried; however, the height of the basket will not be decreased after the carts are folded, and only articles corresponding to the width of the basket can be placed in the carts in outdoor leisure activities such as camping and traveling, so the carrying capacity is limited, and the carts cannot be used for carrying people or for other leisure fun activities.

### BRIEF SUMMARY OF THE INVENTION

In view of the defects in the prior art, the invention provides a cart with sliders. When the cart with sliders is used, users can decrease the height of the side faces of the cart to place articles exceeding the width of the cart in the cart, and the cart can also be used for carrying children or adults or for other outdoor activities.

To fulfil the above objective, the invention adopts the following technical solution: a cart with sliders comprises a hand lever, a front frame, a back frame, two symmetrical side frames and a chassis, wherein the hand lever is rotatably connected with the front frame, the front frame and the back frame are identical in structure, the front frame comprises two vertical tubes, two upper fixed seats, an upper horizontal tube and a lower horizontal tube, two ends of the upper horizontal tube are mounted on the two upper fixed seats, two ends of the lower horizontal tube are connected with lower ends of the two vertical tubes, and casters are mounted at the lower ends of the vertical tubes or on the lower horizontal tube;

Each of the side frames comprises two X-shaped cross tubes and two sliders, wherein one ends of the two X-shaped cross tubes are articulated, the sliders are disposed around the vertical tubes and are able to slide upwards and downwards, tops of the other ends of the two X-shaped cross tubes are riveted to the slider on the front frame and the slider on the back frame respectively, and bottoms of the other ends of the two X-shaped cross tubes are riveted to the lower horizontal tube of the front frame and the lower horizontal tube of the back frame respectively;

The chassis comprises a bottom tube and two bottom frames, wherein one ends of the two bottom frames are articulated, and the other ends of the two bottom frames are riveted to the front frame and the back frame respectively; and the bottom tube is arranged below the bottom frames, and two ends of the bottom tube are riveted to an upper articulated joint of the two X-shaped cross tubes of one side frame and an upper articulated joint of the two X-shaped cross tubes of the other side frame respectively.

In one state, users can slide the sliders to the highest position, and the X-shaped cross tubes are driven to form the side frames with a large height; in the other state, the X-shaped cross tubes can be lowered by means of the sliders to decrease the height of the side frames, such that the height of the side faces of the cart is decreased; moreover, the bottom frames are supported by the bottom tube connected with the two side frames, such that the support capacity of the chassis of the whole cart with sliders is enhanced. Users can adjust the side frames to carry people or articles as actually needed, and the flexibility of the cart is high.

Furthermore, the two ends of the upper horizontal tube are detachably connected with the upper fixed seats at upper ends of the two vertical tubes.

Further, two sides of one ends of the two bottom frames are articulated through bottom frame connecting pieces, and left and right sides of the other end of each of the two bottom frames are riveted to the two ends of the corresponding lower horizontal tube respectively.

Furthermore, U-shaped parts are arranged at the two ends of the lower horizontal tube, the U-shaped parts have openings facing a center and bottoms fixed on the lower horizontal tube, and ends of the left and right sides of the other end of each of the two side frames stretch into the openings to be riveted and are able to rotate upwards and downwards.

Further, the two X-shaped cross tubes are articulated through cross tube connecting pieces, each of the cross tube connecting pieces comprises a left connecting piece and a right connecting piece which are symmetrical in structure, one end of the left connecting piece and one end of the right connecting piece are rotatably connected, and the other end of the left connecting piece or the other end of the right connecting piece is inlaid in an opening of one cross tube to be fixed.

Further, the hand lever comprises a handle, a telescopic rod and a bracket base which are connected in sequence, and the bracket base is rotatably connected with the lower horizontal tube and is able to rotate forward and backward;

Further, each of the casters comprises a fixing shaft, a wheel carrier and wheel which are sequentially arranged from top to bottom.

Further, the cart with sliders further comprises a cloth bag arranged on the chassis, wherein mounting parts are arranged on front and back sides of the cloth bag and are detachably mounted on the two upper horizontal tubes, and four sides of the cloth bag are detachably connected.

Furthermore, connecting belts are arranged on left and right sides of the cloth bag, and two ends of each of the connecting belts are detachably connected with one fixed seat of the front frame and one fixed seat of the back frame respectively.

Furthermore, buckles are arranged at the two ends of each connecting belts, hooks are arranged on the upper fixed seats, and the buckles are hooked on the hooks.

Furthermore, vertical edges of the four sides of the cloth bag are detachably connected through zippers or hook-and-loop fasteners.

By adopting the technical solution, the invention has the following beneficial effects: according to requirements, users can transport articles directly by means of the rectangular frame structure formed by the front frame, the back frame, the side frames and the chassis, or can slide the sliders downwards to decrease the height of the side frames to open the side faces of the cart to transport long and thin articles placed in the cart in the width direction, or the cart can carry children or adults on the chassis or can be used for other leisure activities; the bottom tube connected with the two side frames is arranged on the chassis, such that the bottom frames can be supported more stably; and the whole cart is simple in structure, higher in flexibility, wider in application range, higher in support capacity, and more convenient to use.

### BRIEF DESCRIPTION OF THE SEVERAL VIEWS OF THE DRAWINGS

FIG. 1 is a three-dimensional view of a cart with sliders in one embodiment;

FIG. 2 is a side view of the cart with sliders;

FIG. 3 is an exploded view of the cart with sliders;

FIG. 4 is a view of the cart with sliders in a folded state;

FIG. 5 is a three-dimensional view of the cart with sliders in the presence of a cloth bag;

FIG. 6 is a three-dimensional view of the cart with sliders and the cloth bag;

FIG. 7 is a three-dimensional view of a cart with sliders in another embodiment.

In the figures: 1, front frame; 11, vertical tube; 12, upper horizontal tube; 13, lower horizontal tube; 14, upper fixed seat; 141, hook; 142, tube sleeve; 2, back frame; 3, side frame; 31, X-shaped cross tube; 32, slider; 33, cross tube connecting piece; 34, upper articulated joint; 4, bottom frame; 41, bottom tube; 42, bottom frame; 421, bottom side tube; 422, bottom straight tube; 423, bottom horizontal tube; 43, bottom frame connecting piece; 431, circular part; 44, U-shaped part; 45, connecting piece; 46, bent piece; 5, hand lever; 51, handle; 52, telescopic rod; 53, bracket base; 54, U-shaped connecting piece; 6, caster; 61, fixing shaft; 62, wheel carrier; 63, wheel; 7, cloth bag; 71, mounting part; 72, connecting belt; 73, buckle; 74, vertical edge.

### DETAILED DESCRIPTION OF THE INVENTION

Specific embodiments of the specific solution of the invention will be further expounded below in conjunction with the accompanying drawings to gain a better understanding of the technical solution of the invention.

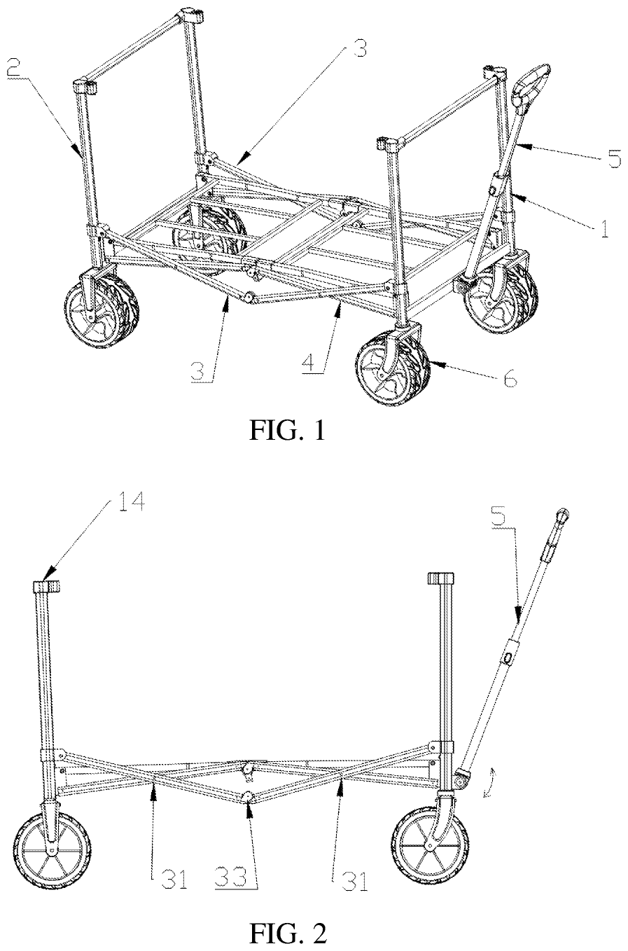

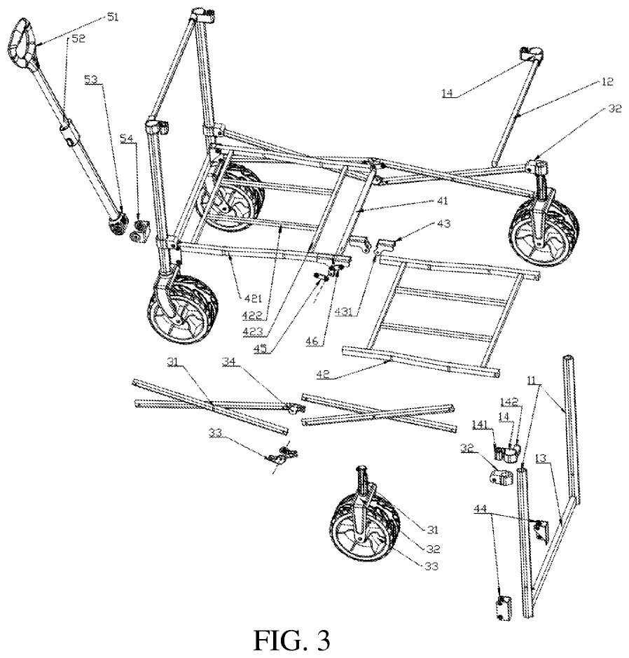

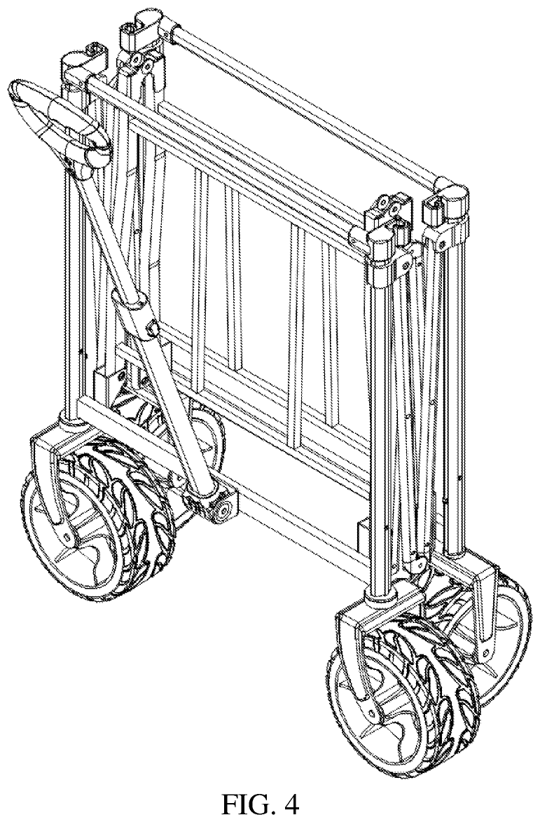

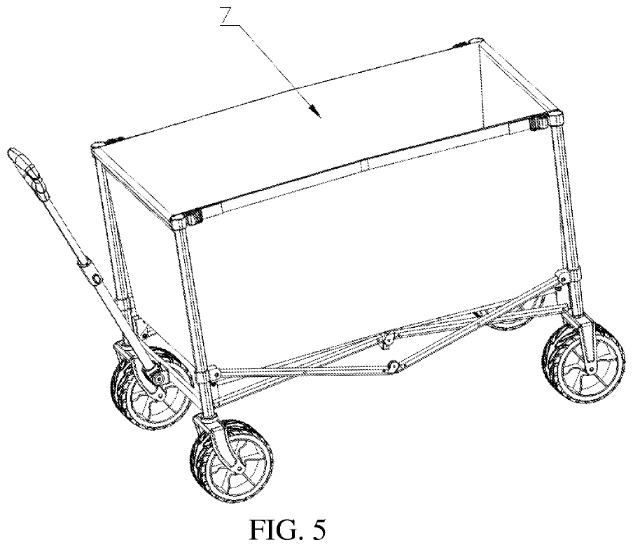

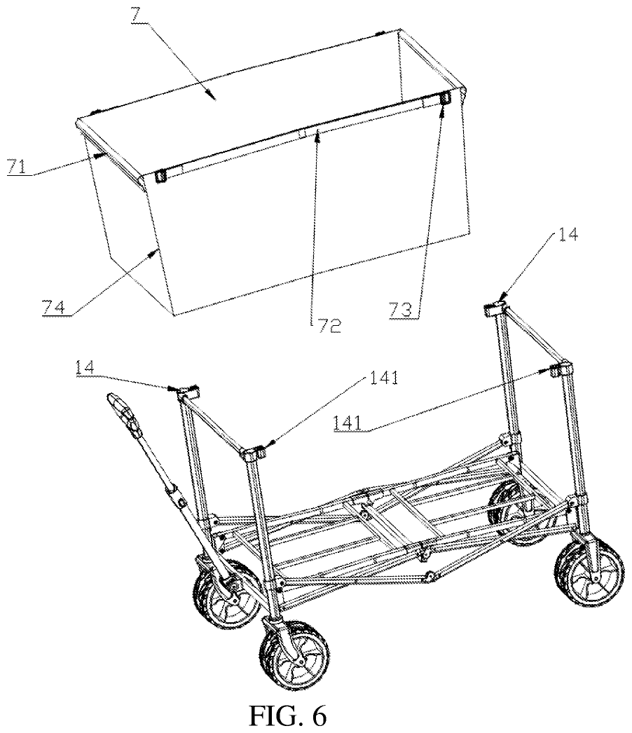

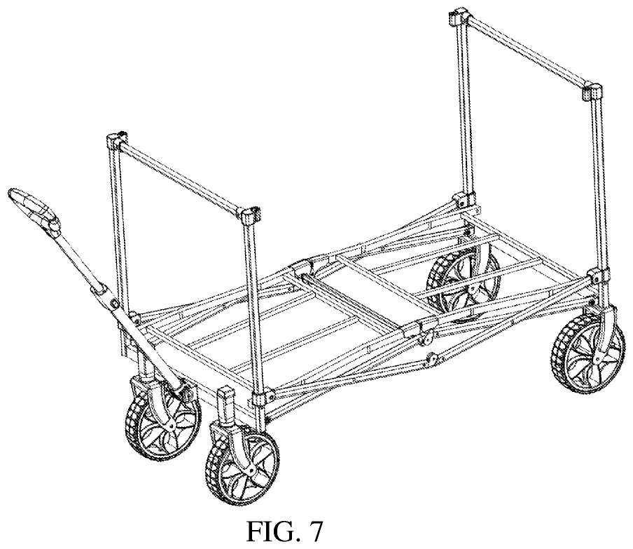

As shown in FIG. 1-FIG. 6, this embodiment discloses a cart with sliders, which mainly comprises a front frame 1, a back frame 2, two symmetrical side frames 3, a chassis 4, a hand lever 5, and four casters 6. Wherein, the hand lever 5 is rotatably connected with the front frame 1; the front frame 1 and the back frame 2 are identical in structure, the front frame 1 comprises two vertical tubes 11, an upper horizontal tube 12 and a lower horizontal tube 13, the upper horizontal tube 12 is connected with upper ends of the two vertical tubes 11, the lower horizontal tube 13 is connected with lower ends of the two vertical tubes 11, and the casters 6 are arranged at the lower ends of the vertical tubes 11. Or, the casters 6 of the cart with sliders are fixed on the lower horizontal tubes 13, as shown in FIG. 7.

In this embodiment, the front frame 1 or the back frame 2 further comprises two upper fixed seats 14 disposed around tops of the vertical tubes 11. Two end of the upper horizontal tube 12 are detachably connected with the upper fixed seats 14 at the upper ends of the two vertical tubes 11. Specifically, a tube sleeve 142 is arranged on one side of each of the two the upper fixed seats 14, and the ends of the upper horizontal tube 12 are inlaid in the tube sleeves 142. The vertical tubes 11 or the upper horizontal tube 12 is preferably an oval tube, and the lower horizontal tube 9 is preferably a square tube.

In this embodiment, each of the side frames 3 comprises two X-shaped cross tubes 31, two sliders 32, two cross tube connecting pieces 33 and a connecting belt 34, wherein one ends of the two X-shaped cross tubes 31 are articulated, the two sliders 32 are disposed around the two vertical tubes 11 on a same side of the front frame 1 and the back frame 2 respectively and are able to slide upwards and downwards, tops of the other ends of the two X-shaped cross tubes 31 are riveted to the slider 32 on the front frame 1 and the slider 32 on the back frame 2 respectively, and bottoms of the other ends of the X-shaped cross tubes 31 are riveted to the lower horizontal tube 13 of the front frame 1 and the lower horizontal tube 13 of the back frame 2 respectively.

The two X-shaped cross tubes 31 are articulated through the cross tube connecting pieces 33. Each of the cross tube connecting pieces 33 comprises a left connecting piece and a right connecting piece which are symmetrical in structure, wherein a round end of the left connecting piece is rotatably connected with a round end of the right connecting piece, and the other end of the left connecting piece or the other end of the right connecting piece is inlaid in an opening of one cross tube and is fixed with a fastener (such as a screw).

In this embodiment, the chassis 4 comprises a bottom tube 41, two bottom frames 42 and two bottom frame connecting pieces 43, wherein one ends of the two bottom frames 42 are articulated, and the other ends of the two bottom frames 42 are riveted to the front frame 1 and the back frame 2 respectively; the bottom tube 41 is arranged below the bottom frames 42, and two ends of the bottom tube 41 are riveted to an upper articulated joint 34 of the two X-shaped cross tubes of one side frame 3 and an upper articulated joint 34 of the two X-shaped cross tubes of the other side frame 3 respectively. Left and right sides, close to the middle, of the two bottom frames 42 are connected through the two bottom frame connecting pieces 43 respectively. Left and right sides, away from the middle, of each bottom frame 42 are riveted to two ends of the corresponding horizontal tube 13 respectively.

Each of the bottom frames 42 comprises two bottom side tubes 421 fixed together, two bottom straight tubes 422 and two bottom horizontal tubes 423, wherein each of the two bottom side tubes 421 has a wide side and a narrow side, the two bottom side tubes are located on a left side and a right side respectively, the two bottom horizontal tubes 423 are parallelly connected with the two bottom side tubes 421, the two bottom straight tubes 422 are parallelly connected with the two bottom horizontal tubes 423, the bottom frame connecting pieces 43 are U-shaped pieces, circular parts 431 extend from one end of the U-shaped pieces, openings of the U-shaped pieces face downwards, the narrow sides of the bottom side tubes 421 are inlaid in the openings of the U-shaped pieces, and the two circular parts 431 on the left and right sides, close to the middle, of the two bottom frames 42 are riveted; and the wide side of each bottom side tube 421 is inlaid in an opening of a U-shaped part 44, and bottoms of the two U-shaped parts 44 are fixed on two sides of the corresponding lower horizontal tube 13 through welding or screws. The tubes of the bottom frames 42 and the bottom tube 41 are preferably square tubes.

The bottom frames 42 adopts a fixing structure formed by horizontal tubes and vertical tubes, so when the chassis 4 needs to be folded, users just need to pull upwards the bottom tube 41 below the two bottom frames 41 to drive the two bottom frames 42 to move upwards to be folded, and the upper articulated joint 34 of the two X-shaped cross tubes in the middle of each side frame is driven to move upwards at the same time.

Two ends of the bottom tube 41 are riveted to the upper articulated joints 34 in the middle of the two side frames 3 respectively. Because left and right tubes, close to the middle of the two X-shaped cross tubes are articulated through the cross tube connecting pieces 33, the upper articulated joint 34 corresponds to the cross to be connecting piece 33 at the upper end. The bottom tube 41 is riveted and matched with the upper articulated joints 34 of the X-shaped cross tubes 31 through two metal sheets. Specifically, a lower end of a connecting piece 45, a bent portion of a bent piece 46 and one upper articulated joint 34 are riveted, the lower end of the bent piece 46 is fixed at one end of the bottom tube 41, and an upper end of the bent piece 46 and an upper end of the connecting piece 45 are riveted to the tubes, close to the middle, of the two X-shaped cross tubes respectively.

Each of the cross tube connecting piece 33 comprises a left connecting piece and a right connecting piece which are symmetrical in structure, one end (round end) of the left connecting piece is rotatably connected with one end (round end) of the right connecting piece, and the other end of the left connecting piece 121 or the other end of the right connecting piece 122 is inlaid in an opening of one X-shaped cross tube 31 and is fixed with a fastener (such as a screw).

In this embodiment, the hand lever 5 comprises a handle 51, a telescopic rod 52 and a bracket base 53 which are connected in sequence, wherein the handle 51 and the bracket base 53 are disposed around an upper end and a lower end of the telescopic rod 52 respectively, and the bracket base 53 is rotatably connected with the lower horizontal tube 13 of the front frame 1 and is able to rotate forward and backward. The bracket base 53 is riveted to a U-shaped connecting piece 54, mounted in the middle of the lower horizontal tube 9, through a hinge pin.

In this embodiment, each of the casters 6 comprises a fixing shaft 61, a wheel carrier 62 and a wheel 63 which are sequentially arranged from top to bottom, wherein the fixing shaft 53 penetrates through the wheel carrier 51, and then an upper end of the fixing shaft 53 is inserted into the corresponding vertical tube 11 from the lower end of the vertical tube 11, as shown in FIG. 1; or, the fixing shaft 53 on the front frame (or back frame) is fixed on the lower horizontal tube 13 by welding or through other methods, as shown in FIG. 7. Preferably, the casters 6 on the front frame 1 are universal casters 6, and the casters 6 on the back frame 2 are directional or universal casters.

In one embodiment, the cart further comprises a cloth bag 7 arranged on the chassis 4, wherein the cloth bag 7 is rectangular, the top of the cloth bag 7 is open, and four sides of the cloth bag 7 correspond to the front frame 1, the back frame 2 and the two side frames 3 respectively. Because the cart is mainly formed by the front frame 1, the back frame 2, the two side frames 3 and the chassis 4, gaps between the components are large, large articles can be securely placed in the art, but small articles in the cart may fall out when the cart moves; in view of this, the detachable cloth bag 7 is mounted on the cart to store small articles, and the cloth bag 7 can be detached to be cleaned after use. Mounting parts 71 are arranged on front and back sides of the cloth bag 7 and are detachably mounted on the two upper horizontal tubes 12, and left and right sides of the cloth bag are limited by the connecting belts 72. The mounting parts 71 are preferably hook-and-loop fasteners, and are disposed around the upper horizontal tubes.

In order to fix the left and right sides of the cloth bag 7, connecting belts 72 are arranged on upper edges of the left and right sides of the cloth bag 7, two ends of each connecting belt 72 are detachably connected with one upper fixed seat 14 of the front frame 1 and one upper fixed seat 14 of the back frame 2 respectively. Specifically, a buckle 73 is arranged at each of the two ends of each connecting belt 72, hooks 141 are arranged on the upper fixed seats 14, and the buckles 73 are hooked on the hooks 141. The left and right sides, provided with the connecting belts 34, of the cloth bag 7 are fixed by means of the buckles 73 (such as slide buckles) and the hooks 141.

Specifically, vertical edges 74 of the four sides of the cloth bag are detachably connected through zippers or hook-and-loop fasteners, such that the sides, corresponding to the side frames 3, of the cloth bag can be opened.

The two side frames 3 of the cart with sliders are connected mainly by means of the bottom tube 41, such that the two articulated bottom frames 42 are supported at the center and can be pulled to be folded quickly.

It should be noted that the above embodiments are merely preferred ones of the invention and are used to explain the technical principle of the invention. Those skilled in the art should understand that the invention is not limited to these specific embodiments described here, and those skilled in the art can make various changes, readjustments and substitutions without departing from the protection scope of the invention. Thus, although the invention has been described in detail with reference to the above embodiments, the invention is not limited to the above embodiments, and may include more other equivalent embodiments without departing from the concept of the invention. The scope of the invention is defined by the appended claims.

What is claimed is:

1. A cart with sliders, comprising:
a hand lever;
a front frame;
a back frame;
two symmetrical side frames and a chassis;
the hand lever being rotatably connected with the front frame;
wherein the front frame and the back frame are identical in structure;
wherein the front frame comprises two vertical tubes, two upper fixed seats, an upper horizontal tube and a lower horizontal tube, two ends of the upper horizontal tube are mounted on the two upper fixed seats, two ends of the lower horizontal tube are connected with lower ends of the two vertical tubes, and casters are mounted at the lower ends of the vertical tubes or on the lower horizontal tube;
each of the side frames comprises two X-shaped cross tubes and two sliders, wherein one ends of the two X-shaped cross tubes are articulated, the sliders are disposed around the vertical tubes and are able to slide upwards and downwards, tops of the other ends of the two X-shaped cross tubes are riveted to the slider on the front frame and the slider on the back frame respectively, and bottoms of the other ends of the two X-shaped cross tubes are riveted to the lower horizontal tube of the front frame and the lower horizontal tube of the back frame respectively;
the chassis comprises a bottom tube and two bottom frames, wherein one ends of the two bottom frames are articulated, and the other ends of the two bottom frames are riveted to the front frame and the back frame respectively; and the bottom tube is arranged below the bottom frames, and two ends of the bottom tube are riveted to an upper articulated joint of the two X-shaped cross tubes of one side frame and an upper articulated joint of the two X-shaped cross tubes of the other side frame respectively.

2. The cart with sliders according to claim 1, wherein the two ends of the upper horizontal tube are detachably connected with the upper fixed seats at upper ends of the two vertical tubes.

3. The cart with sliders according to claim 1, wherein two sides of one ends of the two bottom frames are articulated through bottom frame connecting pieces, and left and right sides of the other end of each of the two bottom frames are riveted to the two ends of the corresponding lower horizontal tube respectively.

4. The cart with sliders according to claim 3, wherein U-shaped parts are arranged at the two ends of the lower horizontal tube, the U-shaped parts have openings facing a center and bottoms fixed on the lower horizontal tube, and ends of the left and right sides of the other end of each of the two side frames stretch into the openings to be riveted and are able to rotate upwards and downwards.

5. The cart with sliders according to claim 1, wherein the two X-shaped cross tubes are articulated through cross tube connecting pieces, each of the cross tube connecting pieces comprises a left connecting piece and a right connecting piece which are symmetrical in structure, one end of the left connecting piece and one end of the right connecting piece are rotatably connected, and the other end of the left connecting piece or the other end of the right connecting piece is inlaid in an opening of one said cross tube to be fixed.

6. The cart with sliders according to claim 1, wherein the hand lever comprises a handle, a telescopic rod and a bracket base which are connected in sequence, and the bracket base is rotatably connected with the lower horizontal tube and is able to rotate forward and backward;
or, each of the casters comprises a fixing shaft, a wheel carrier and wheel which are sequentially arranged from top to bottom, and the fixing shaft is inlaid in the lower end of the corresponding vertical tube or is welded on the corresponding lower horizontal tube.

7. The cart with sliders according to any one of claims 1-6, further comprising a cloth bag arranged on the chassis, wherein mounting parts are arranged on front and back sides of the cloth bag and are detachably mounted on the two upper horizontal tubes, and four sides of the cloth bag are detachably connected.

8. The cart with sliders according to claim 7, wherein connecting belts are arranged on left and right sides of the cloth bag, and two ends of each of the connecting belts are detachably connected with one said fixed seat of the front frame and one said fixed seat of the back frame respectively.

9. The cart with sliders according to claim 8, wherein buckles are arranged at the two ends of each said connecting belts, hooks are arranged on the upper fixed seats, and the buckles are hooked on the hooks.

10. The cart with sliders according to claim 7, wherein vertical edges of the four sides of the cloth bag are detachably connected through zippers or hook-and-loop fasteners.
